(19) United States
(12) Patent Application Publication
(10) Pub. No.: US 2023/0047924 A1
(43) Pub. Date: Feb. 16, 2023

(54) LEDGER-BASED VERIFIABLE CODE EXECUTION

(71) Applicant: Truebit Co., Buffalo Grove, IL (US)

(72) Inventor: Jason Richmond Teutsch, Buffalo Grove, IL (US)

(21) Appl. No.: 17/880,876

(22) Filed: Aug. 4, 2022

Related U.S. Application Data
(60) Provisional application No. 63/231,396, filed on Aug. 10, 2021.

(51) Int. Cl. G06F 9/48; H04L 9/32

(52) U.S. Cl. CPC G06F 9/485; H04L 9/3239; H04L 9/3297

(57) ABSTRACT

A system includes a ledger on which a task giver may register a task. The task may include executable code. A task solver may accept the task and execute the code to produce a solver output that is recorded on the ledger. Verifiers may provide competing verifier outputs which may also be recorded on the ledger. The solver and verifiers may compare their outputs to determine if there is agreement. Agreement may signify consistent and accurate execution of the code. Disagreement may indicate the presence of errors. In some cases, the solver and verifiers may compete in a contention-based protocol where a solver may assert control of tokens where the solver identifies an error in verifier execution. Additionally or alternatively, a verifier may assert control of tokens where the verifier identifies an error in solver execution.

### PRIORITY

This application claims priority to U.S. Provisional Pat. Application No. 63/231,396, filed Aug. 10, 2021, titled Distributed-Ledger-Based Verifiable Code Execution, which is incorporated by reference in its entirety.

### TECHNICAL FIELD

This disclosure relates to verifiable execution of code.

### BACKGROUND

Rapid advances in electronics and communication technologies, driven by immense customer demand, have resulted in the widespread adoption of electronic transactions, record keeping, and executable-code-based agreement formation. As one example, e-currencies, such as Bitcoin, have displaced paper currencies in millions of transactions per year. Improvements in tracking and/or knowledge management attached to such electronic interactions and tracking will continue to increase the features and options available to operators engaging in electronic transactions.

### BRIEF DESCRIPTION OF THE DRAWINGS

FIG. 1 shows an example code verification environment.

FIG. 2 shows example solver logic.

FIG. 3 shows an example solver execution system.

FIG. 4 shows example verifier logic.

FIG. 5 shows an example verifier execution system.

FIG. 6 shows example task giver logic.

FIG. 7 shows an example task giver execution system.

### DETAILED DESCRIPTION

A blockchain may include a series of data blocks, the blocks including a code, such as a cryptographic hash or checksum, which may be consistent with the content of previous blocks in the series. In some cases, determining multiple different sets of blocks that produce the same code may be insoluble, prohibitively computationally complex, or otherwise effort intensive enough to frustrate attempts to tamper with the contents of the blockchain while maintaining the self-consistence of the codes. Accordingly, users of the blockchain may have trust that the content of the blockchain remains in an unaltered state as long as the content is consistent with the codes stored on the blockchain.

In various systems, blockchains, or more generally, ledger technologies (such as distributed ledgers, and/or other recordation systems which may use blockchains and/or self-consistent cryptographic architectures other than blockchains), provide a platform for multiple parties to share access to data with the ability to verify the validity and integrity of that data. Various implementations that may be used with blockchains may also be used with other ledger technologies.

In various implementations, a task giver may provide a task that includes the execution of code. In various scenarios, the executable code associated with the task may be code for which the task giver may later rely on (or later attempt to prove) as executed accurately to produce the result being purported as correct by the task giver. In some cases, the task giver may use a code execution platform in which the execution result may be challenged to ensure execution was accurate and done with fidelity to the provided code.

In various implementations, a code execution protocol may include execution of the code by a solver that produces a solver output. The solver output may be compared to one or more verifier outputs produced by verifiers purporting to execute identical code. When the outputs match, the match may provide evidence that the code was executed accurately and with fidelity by both solver and verifier(s). Mismatches may provide evidence of inaccurate and/or low-fidelity execution of the code by one or more of the parties. Further analysis, initiated as result of the mismatch, may provide the origin of the mismatch to assist in the identification of error/inaccuracies in the execution.

In some cases, the solver and/or verifiers may execute the code in a contention-based protocol where the solver and/or verifiers may receive a set of tokens for accurate execution. Additionally or alternatively, solver and/or verifiers may surrender a counter-set of tokens for inaccurate, incomplete, and/or otherwise low-fidelity execution. Additionally or alternatively, solver and/or verifiers may act in contention where providing an accurate execution when a counterpart provides inaccurate execution entitles the party prevailing in the contention protocol control of the counter-set of the other party. Control (e.g., by a solver, verifier, task giver or other party) of a token set/counter-set may, in some cases, include control of a sub-set of the set/counter-set. In other words, control of a set/counter-set may not necessarily be total.

The task including the executable code, the token sets (verifier sets/counter-sets, solver sets/counter sets, and/or other token sets), the solver output, the verifier output(s), and/or other data from the contention-based protocol may be recorded on a ledger. The record from the ledger may be later referenced as evidence that the code was executed as recorded.

In an example implementation, the task giver may cause registration of a task on a ledger. The task may include a reference to executable task code (e.g., such as a pointer to a location for the code, a hash of the code, and/or other reference), a designation and/or inclusion (as digital assets) of a solver token set and/or a verifier token set. The token set may include computation exchange tokens for the purpose of tracking computational inputs and output, such as TRU tokens and/or other computation exchange tokens. In some cases, cryptocurrency coins and/or off-chain credits may be used as tokens. In some cases, the task giver may record (e.g., cause recordation through a consensus protocol for the ledger) the task with a digital identity such as a digital signature to establish that the task giver was the actual provider of the task.

A solver may accept the registered task by registering a solver token counter-set. In some cases, the size of the counter-set may be proportional to the size of the corresponding set (e.g., 1:1, 1:2, 2:1, or other proportion). In some cases, the sizes of the set and corresponding counter-set may be defined in the task. In some cases, the sizes of the set and corresponding counter-set may be defined as defaults for the contention-based protocol. In some cases, the task giver may have a first opportunity to register as the task solver before other potential solvers may be allowed to register (e.g., a first refusal).

The solver may perform the registered task by executing the task code and generating a solver output. The solver may generate a solver commitment corresponding to the solver output. The solver commitment may include the solver output in a cryptographic form that binds the solver to the solver output without disclosing the solver output. For example, the solver commitment may include a hash the solver output with a random salt. In the example, the solver could prove that the solver had possession of the solver output at the time the solver commitment was recorded by providing the hash key and the salt. The solver may cause recordation of the solver commitment on the ledger.

In some implementations, the solver or verifier may be constrained in the amount of time that is allowed for execution of the task code. For example, the registered task may include a timeout window in which the code should be executed. In some cases, the timeout window may be expressed in time value such as hours, minutes, seconds, microseconds, or other time value. In some cases, the timeout window may be expressed in a ledger-related value. For example. The timeout window may be expressed as a block limit. A block limit may include a specific number of blocks that may be added to a timing ledger before the timeout window expires. In some cases, the timing ledger may be the same ledger as the ledger on which the registered task is posted. In some cases, the timing ledger may be different from the ledger on which the registered task is posted. For example, the ledger on which the registered task is posted may include a private, service/application specific, and/or limited access blockchain while the timing ledger may include a public and/or widely used blockchain such as Ethereum and/or Bitcoin.

In some implementations, the solver may cause recordation through an attempt to execute the task code. Recordation of an attempt may allow the solver to assert that a good-faith attempt to execute the task code within a timeout window was performed. In some cases, recording an attempt may establish that the reason for a timeout in execution was an insufficiently long timeout window. Accordingly, the solver may have a reduced penalty (or completely avoid a penalty) for the timeout. In some cases, a penalty may be assigned to the task giver for providing an insufficient timeout window. In some cases, regardless of whether the timeout window was sufficient, the task giver may receive some penalty.

In some implementations, an attempt to record may include metering of the computational resources expended during the attempt. The solver or verifier may inject metering at runtime or, in some cases, the task giver may inject it ahead of time. In some cases, the attempt record may include posting a signed record of the attempt to run within the bounds of computational resources as defined by the metering. In some cases, metering may be implicitly implemented and may not necessarily rely on explicit injection into the record. For example, certain detailed computational steps may have readily ascertainable/apparent computing resource requirements. Metering may be implemented by capturing such implicit computing resource requirements. The signed record may be released for recordation when conditions for a good-faith attempt are met. For example, the conditions may include reception of the task code, initiation of execution of the task code, non-interruption of execution (and/or interruption below a defined threshold), and/or other conditions indicating a real attempt to execute the code. In some cases, indications of bad faith execution may prevent release. For example, parallel execution of other tasks (e.g., beyond an allowed number of parallel executions), constraints on total allowed computational resource expenditures, or other computational power limits may indicate a bad-faith attempt.

One or more verifiers, which may register verifier token counter-sets to establish verifier status, may execute the task code to generate verifier outputs. The verifier(s) may record verifier commitments on the ledger.

The solver and verifier(s) may release keys (e.g., solver keys and/or verifier keys) and/or salts corresponding to their commitments to reveal their corresponding outputs. The solver output may be compared to the one or more verifier outputs to implement the contention-based protocol. If a verifier output matches the solver output, the corresponding verifier may claim a verifier token set. If there is a mismatch, the solver and verifier may compete to establish that the mismatch was the result of an error by their counterpart. Establishing a counterpart error may allow the prevailing party to claim the counter-set of the party that committed the error. For example, a prevailing verifier may claim the solver counter-set (e.g., assert control of). For example, a prevailing solver may assert control of the verifier counter-set. In some cases, assertion of control of a token set may include transferring the tokens (or a portion thereof) to an account and/or identity associated with the party asserting control.

If no mismatches are found or all mismatches are resolved in favor of the solver, the solver may assert control of the solver token set. In some cases, verifier(s) that prevail over a solver may assert control of the solver token set.

In some cases, to avoid self-contention (e.g., where a single party acts as both solver and verifier), assertion of control may be made lossy for counter-sets won during contention. In other words, a portion of the tokens from a set transferred as the result of contention may be destroyed or otherwise removed from the counter-set rather than passed through contention. Thus, gain achieved solely through self-contention may not necessarily be possible. In some cases, losses may be guaranteed for instances of self-contention.

Changes in system state with regard to task code execution by solvers and/or verifiers may be managed by a smart contract, and/or interpreted locally in solver and verifier clients based on ledger commitments made during the tasking process. In some cases, a designated controller node (e.g., designated via ledger consensus rules or a trusted server) may influence changes in system state.

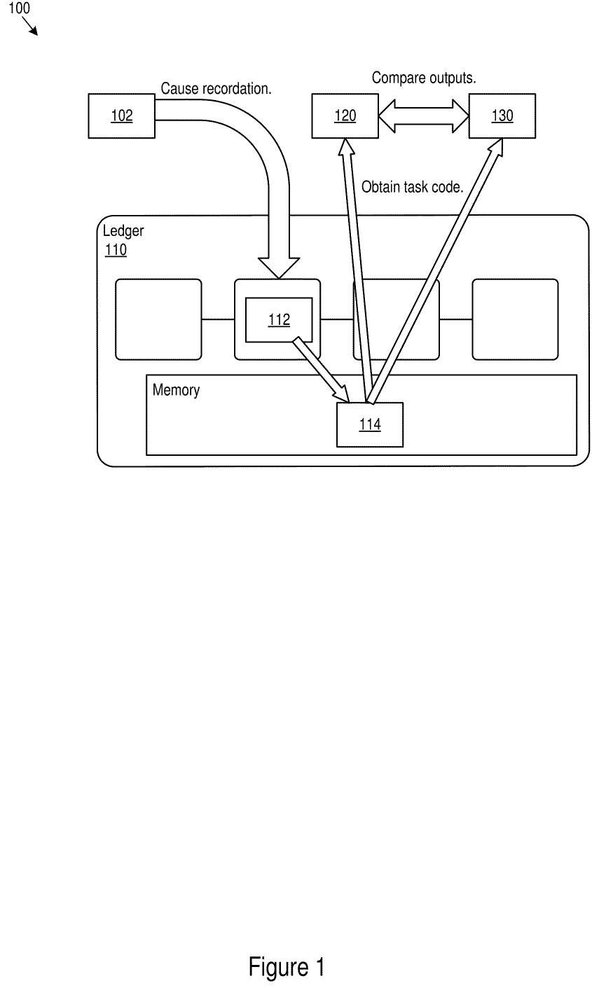

FIG. 1 shows an example code verification environment 100. In the example code verification environment, a task giver 102 may generate a registered task 112 on a ledger 110. The registered task 112 may include task code 114 for verified execution. As discussed above, the registered task 112 may designate various parameters for the verified execution of the task code 114, such as a solver timeout window, a solver token set, one or more verifier token sets, solver / verifier qualifications or requirements, and/or other parameters to support verified execution of the task code 114. A solver 120 may accept the registered task by recording acceptance of the task on the ledger and/or otherwise indicating acceptance. One or more verifiers 130 may enter into the contention protocol with the solver 120 by recording (or otherwise indicating possession of) competing execution results with those of the solver.

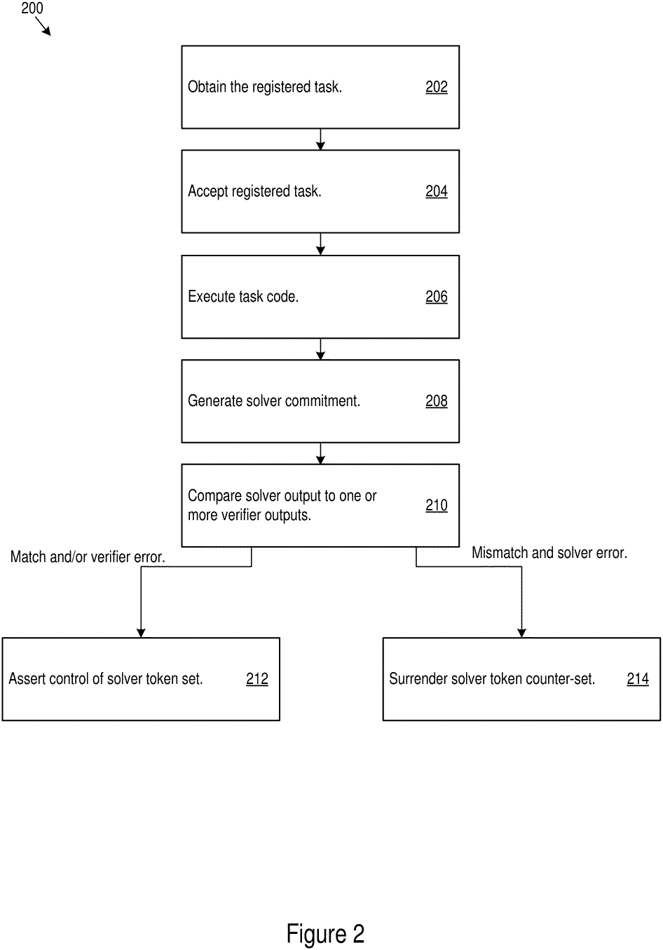

Referring now to FIG. 2, while continuing to refer to FIG. 1, example solver logic 200 is shown. The solver logic 200 may be used to execute one or more solver operations to be performed by the solver 120. In various implementations, the solver logic 200 may perform various operations within the contention protocol, as discussed above. Accordingly, in various implementations, solver logic 200 may operate at least in part as contention protocol logic, which may, in some cases, include combined logic to support operations performed by verifiers 130 and/or task givers 102. The solver logic 120 may be executed on circuitry.

The example solver logic 200 may obtain the registered task 112 on the ledger 110 (202). The solver logic 200 may obtain the task by accessing the ledger 110 and/or off-chain storage associated with the ledger 110. In some cases, the solver logic may receive the registered task 112 as a result of the registered task 112 and/or the task code 114 being sent via network communications, database access operations, and/or other data transfer operations. For example, the solver 120 may accept the registered task 112 (e.g., in accord with 204 below) and then be sent the registered task (or a portion thereof) after acceptance on the ledger. For example, acceptance of the registered task 112 may include specifying an address for delivery of the registered task 112. However, in various implementations, the solver logic 200 may have access to the registered task prior to acceptance. For example, access prior to acceptance may allow of the solver 120 to determine whether acceptance of the registered task 112 is proper, e.g., whether the solver token set is sufficient, whether processing resources are available, whether good-faith execution of task code can likely be completed within any timeout window, whether solver qualifications are met, and/or other factors for determining acceptance.

The example solver logic 200 may accept the registered task 112 (204). For example, the solver logic 200 may record an indication on the ledger 110 that the solver 120 has accepted the task. In some cases, acceptance may include sending an acceptance to the task giver 102. Various acceptance indication schemes may be used.

In various implementations, acceptance of the registered task 112 may reserve the solver role for some duration, e.g., a timeout window, a period until execution output is recorded (e.g., until a completion of a first execution attempt), and/or other period. In various implementations, rules for the ledger and/or elsewhere specified for the contention protocol may include the constraint that simultaneous registered solvers may be disallowed, e.g., only one solver at a time. However, after reservation for a particular solver ends, other prospective solvers (in some cases, including the solver for which the reservation just ended) may be given a chance to accept (e.g., if the first solver fails to complete error-free execution).

Acceptance may include registering and/or otherwise identifying a solver token counter-set. As discussed above, the solver token counter-set may ensure good faith behavior from the solver 120 because the solver 120 may surrender the solver token counter-set if the solver fails to provide a solver output from executing the task code and/or provides a solver output with errors.

The example solver logic 200 may execute the task code 114 (206). For example, after acceptance of the registered task 112, the solver logic 200 may initiate execution of the task code 114. In some cases, the timing of execution may be governed by the task code itself. For example, the task code 114 may include a smart contract. In some cases, execution of the smart contract code may be time with fulfillment of one or more terms of the smart contract. Accordingly, proper completion of execution may be possible only after certain conditions (e.g., those set forth in the smart contract) have occurred.

After completion of the execution of the task code 114, the solver logic 200 may generate a solver commitment based on the solver output from execution of the task code 114 (208). The solver commitment may include one or more cryptographic primitives, e.g., using a solver key, that may demonstrate that the solver has possession of the solver output. The solver logic 200 may cause the solver commitment to be recorded on the ledger 110. In various cases, the recordation of the solver commitment on the ledger may allow the solver logic to prove the solver output had been obtained at least by time that the solver commitment was recorded to the ledger.

In some implementations, timeout windows may be measured from the time of acceptance (e.g., through recordation of the acceptance on the ledger) to the time of recordation of the solver commitment. For blockchain-based ledgers, enforcement of the timeout window may be done through enforcement of a block limit. A block limit may be specified as a maximum number of blocks that may be added to the blockchain before the timeout window expires. Enforcement may be simplified where the acceptance-commitment interval is used. For example, the block limit may be enforced by counting the number of blocks after the acceptance is recorded. If more blocks than that limit are counted before the solver commitment recordation is reached, the solver exceeded the timeout window. For non-blockchain and/or some blockchain based ledgers, a timing ledger (e.g., a timing blockchain) may be used to enforce the block limit. A start block may be indicated (for example, a block identifier may be recorded on the ledger 110 to indicate the start block). Similarly, blocks after the start block on the timing ledger may be counted until the timeout window is exceeded or an end block is designated (e.g., in response to the solver recording a solver commitment on the ledger 110). In some cases (including some cases where the ledger 110 is blockchain-based), the use of a timing ledger may allow for increased standardization (and/or broader-based timing acceptance) by allowing the timing ledger to be selected independently of the ledger 110 used in the contention protocol. For example, this may allow the timing ledger to include a widely referenced or well-known blockchain (e.g., such as Ethereum, Bitcoin, or other well-known blockchain) to be used in timeout judgments without necessarily also requiring the contention protocol be executed on that same blockchain. In some cases, using a well-known blockchain for timing and/or other measurement may increase confidence by participants (e.g., solvers, verifiers, task givers, and/or other participants) that no tampering with timing standards is possible. This may reduce timing disputes among participants.

Other timings may be measured, for example specified start times may be designated (e.g., using various time standards). Other completion conditions may be specified. For example activity on the solver execution system may be monitored. A stop may be determined based on a cessation of activity.

The example solver logic 200 may compare the solver output to one or more verifier outputs (210). In some implementations, the solver logic 200 may reveal the solver output for comparison to the verifier outputs. In some cases, the solver logic 200 may be allowed to reveal the output for comparison once certain conditions have been met (e.g., a particular number of verifiers 130 have posted commitments, a verifier timeout expires, and/or other condition). In some cases, verifiers challenging a particular solver attempt may be barred from providing additional verifier outputs once the solver output is revealed.

The solver logic 200 may attempt to match verifier output and/or prove verifier 130 error where there is mismatch. The solver logic 200 may assert control of the solver token set (212) when the solver output matches the verifier outputs and/or shows the presence of errors in unmatched verifier outputs. In some implementations, the solver logic 200 may surrender one or more portions of the solver token set and/or solver token counter-set (214) when there is a mismatch between one or more verifier outputs and the solver output where no errors are shown in the one or more verifier outputs.

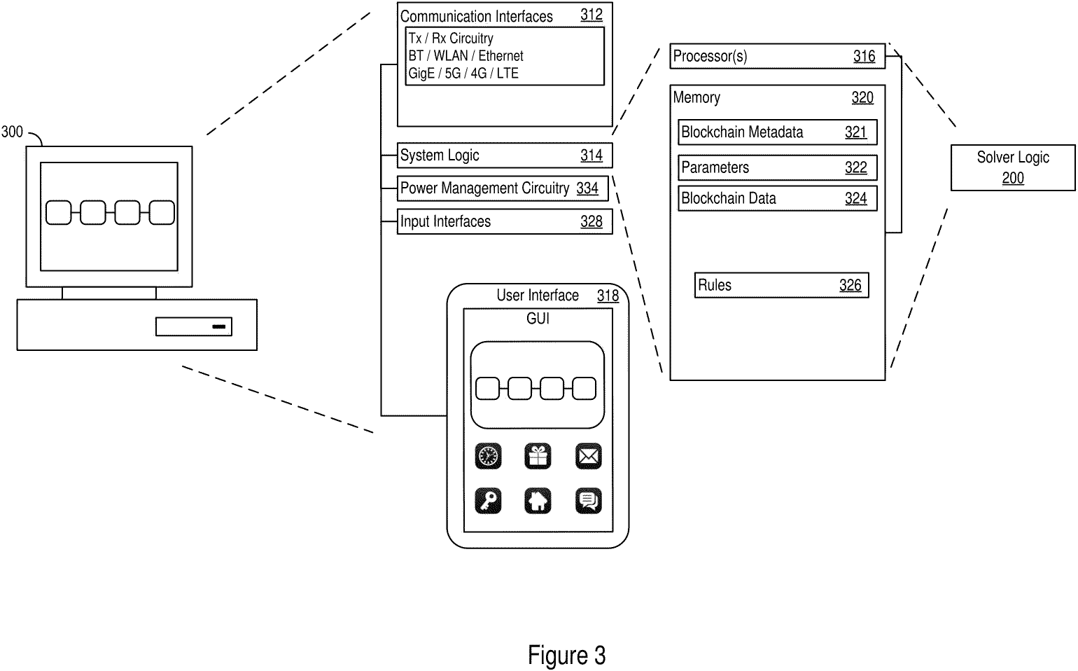

FIG. 3 shows an example solver execution system (SES) 300, which may provide a hardware environment for execution of contention protocol logic including the solver logic 200. When configured using solver logic, such as the example solver logic 200, the hardware of the SES 300 may be special purpose circuitry specifically configured to execute the operations of the solver role in the contention protocol. The SES 300 may be co-located with and/or share hardware with other systems such as the example verifier execution system 500 and/or example task giver execution system 700. The SES 300 may include system logic 314 to support encryption and decryption; commitment generation; task writing; task execution; task verification; and/or other code execution operations. The system logic 314 may include processors 316, memory 320, and/or other circuitry, which may be used to implement the example solver logic 200, any of the logics discussed herein and/or other ledger logic, which may be used to execute ledger updates, execute code, and/or implement the contention-based protocol.

The memory 320 may be used to store blockchain metadata 322 and/or blockchain data 324 used in code execution. The memory 320 may further store parameters 321, such as an encryption key values, generated random salt values, and/or other parameters that may facilitate sharing and manipulation of data. The memory may further store rules 326, which may support execution of contention-based protocols, implementation of blockchain consensus protocols, or other operations.

The memory 320 may further include applications and structures, for example, coded objects, templates, or one or more other data structures to support verifiable code execution. The SES 300 may also include one or more communication interfaces 312, which may support wireless, e.g. Bluetooth, Wi-Fi, WLAN, cellular (5G, 4G, LTE/A), and/or wired, ethernet, Gigabit ethernet, optical networking protocols. Additionally, or alternatively, the communication interface 312 may support secure information exchanges, such as secure socket layer (SSL) or public-key encryption-based protocols for sending and receiving private data. The SES 300 may include power management circuitry 334 and one or more input interfaces 328.

The SES 300 may also include a user interface 318 that may include man-machine interfaces and/or graphical user interfaces (GUI). The GUI may be used to present options for solver acceptance, code execution options, token management, ledger operations, and/or other options.

The SES 300 may be deployed on distributed hardware. For example, various functions of the SES 300, e.g., while implementing solver logic, may be executed on cloud-based hardware, distributed static (and/or semi-static) network computing resources, and/or other distributed hardware systems. In various implementations, centralized and/or localized hardware systems may be used. For example, a unitary server or other nondistributed hardware system may perform solver logic operations.

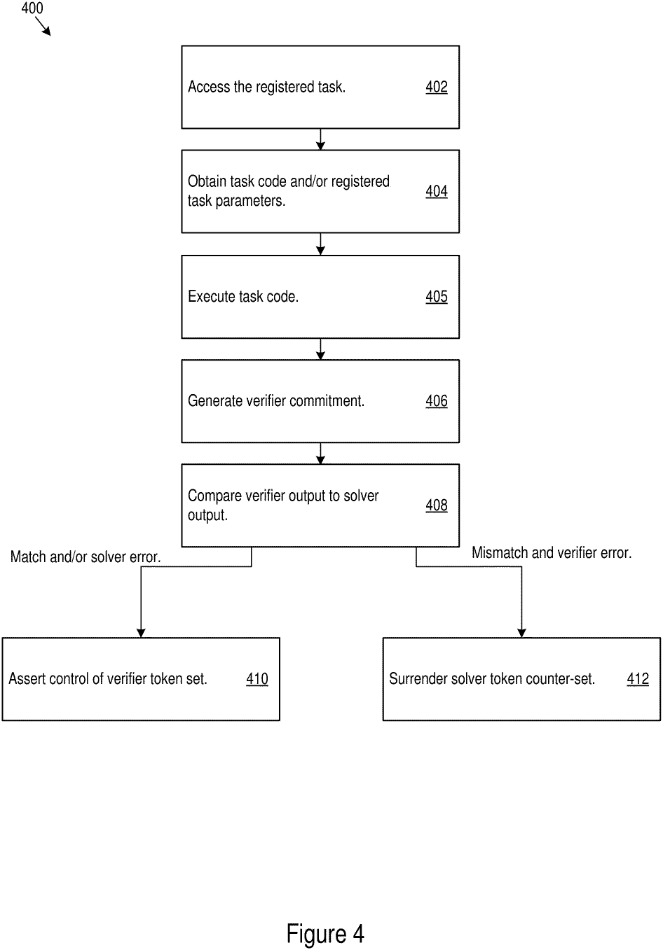

In the contention protocol, example verifier logic 400, shown in FIG. 4, may execute opposite to solver logic 200. Verifier logic 400 may execute the task code and compare the obtained verifier output with the solver output. The verifier 130 may, under specified conditions, assert control of a verifier token set in exchange for producing and providing the verifier output. In various implementations, the verifier may not necessarily be afforded role exclusivity while performing verification. Accordingly, in some cases, a verifier may perform verification without first causing recordation of an acceptance of the registered task. Nevertheless, in some implementations, recordation of a verifier acceptance may be a condition of eventual assertion of control of a verifier token set.

The verifier logic 400 may access the registered task 112 on the ledger 110 (402). Based on the recordations on the ledger, the verifier logic 400 may determine that the registered task 112 has been accepted by the solver 120 and/or that verification recordations are being currently or will be allowed for the registered task 112.

The verifier logic 400 may obtain the task code 114 and/or other parameters for the registered task 112 (404). Obtaining the task code may involve similar pathways to obtaining the task code 114 as solver logic 200, for example, accessing the code on the ledger and/or associated storage, recording a verifier acceptance and receiving the task code 114 via a network communication, and/or other access pathways.

The verifier logic 400 executes the task code to generate a verifier output (405) and, based on the verifier output, generates a verifier commitment, e.g., using a verifier key (406).

When the solver output is available for comparison, the example verifier logic 400 may compare its verifier output to the solver output (408). The verifier logic 400 may attempt to match the verifier output to the solver output and/or identify one or more errors in the solver output. The verifier may assert control of a verifier token set (410) when a match with the solver output is present and/or when an error is found in the solver output. If no match is found and an error is present in the verifier output, the verifier logic may forgo asserting control of the verifier token set (412).

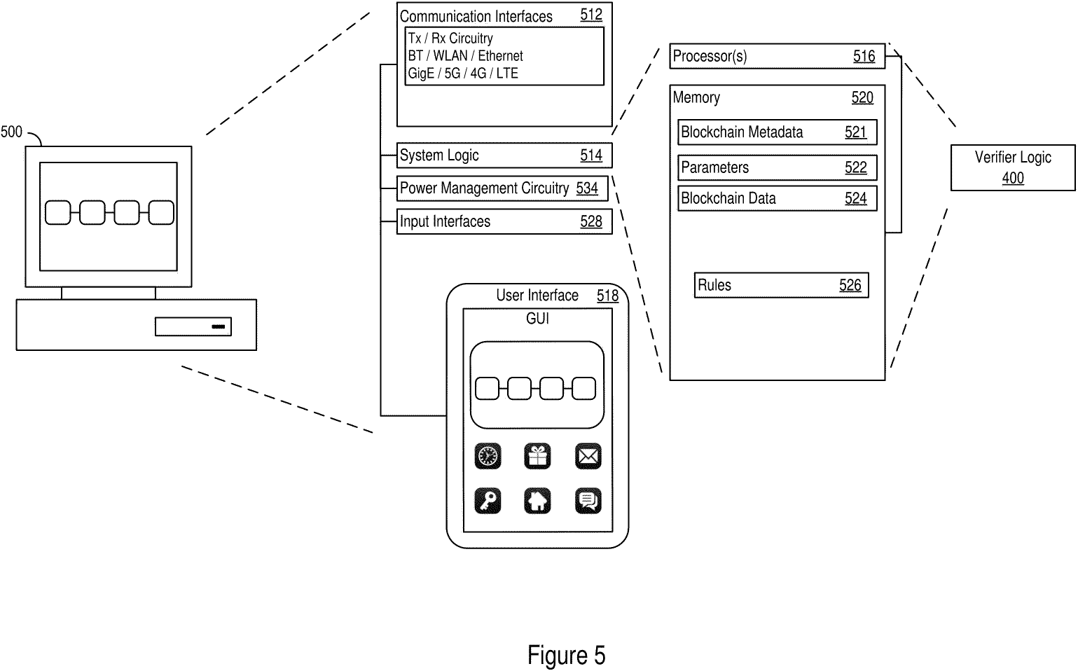

FIG. 5 shows an example verifier execution system (VES) 500, which may provide a hardware environment for execution of contention protocol logic including the verifier logic 400. When configured using verifier logic, such as the example verifier logic 400, the hardware of the VES 500 may be special purpose circuitry specifically configured to execute the operations of the verifier role in the contention protocol. The VES 500 may be co-located with and/or share hardware with other systems such as the example solver execution system 300 and/or example task giver execution system 700. The VES 500 may include system logic 514 to support encryption and decryption; commitment generation; task writing; task execution; task verification; and/or other code execution operations. The system logic 514 may include processors 516, memory 520, and/or other circuitry, which may be used to implement the example verifier logic 400, any of the logics discussed herein and/or other ledger logic, which may be used to execute ledger updates, execute code, and/or implement the contention-based protocol.

The memory 520 may be used to store blockchain metadata 522 and/or blockchain data 524 used in code execution. The memory 520 may further store parameters 521, such as encryption key values, generated random salt values, and/or other parameters that may facilitate sharing and manipulation of data. The memory may further store rules 526, which may support execution of contention-based protocols, implementation of blockchain consensus protocols, or other operations.

The memory 520 may further include applications and structures, for example, coded objects, templates, or one or more other data structures to support verifiable code execution. The VES 500 may also include one or more communication interfaces 512, which may support wireless, e.g. Bluetooth, Wi-Fi, WLAN, cellular (5G, 4G, LTE/A), and/or wired, ethernet, Gigabit ethernet, optical networking protocols. Additionally, or alternatively, the communication interface 512 may support secure information exchanges, such as secure socket layer (SSL) or public-key encryption-based protocols for sending and receiving private data. The VES 500 may include power management circuitry 534 and one or more input interfaces 528.

The VES 500 may also include a user interface 518 that may include man-machine interfaces and/or graphical user interfaces (GUI). The GUI may be used to present options for code execution options, token management, ledger operations, and/or other options.

The VES 500 may be deployed on distributed hardware. For example, various functions of the VES 500, e.g., while implementing verifier logic, may be executed on cloud-based hardware, distributed static (and/or semi-static) network computing resources, and/or other distributed hardware systems. In various implementations, centralized and/or localized hardware systems may be used. For example, a unitary server or other nondistributed hardware system may perform verifier logic operations.

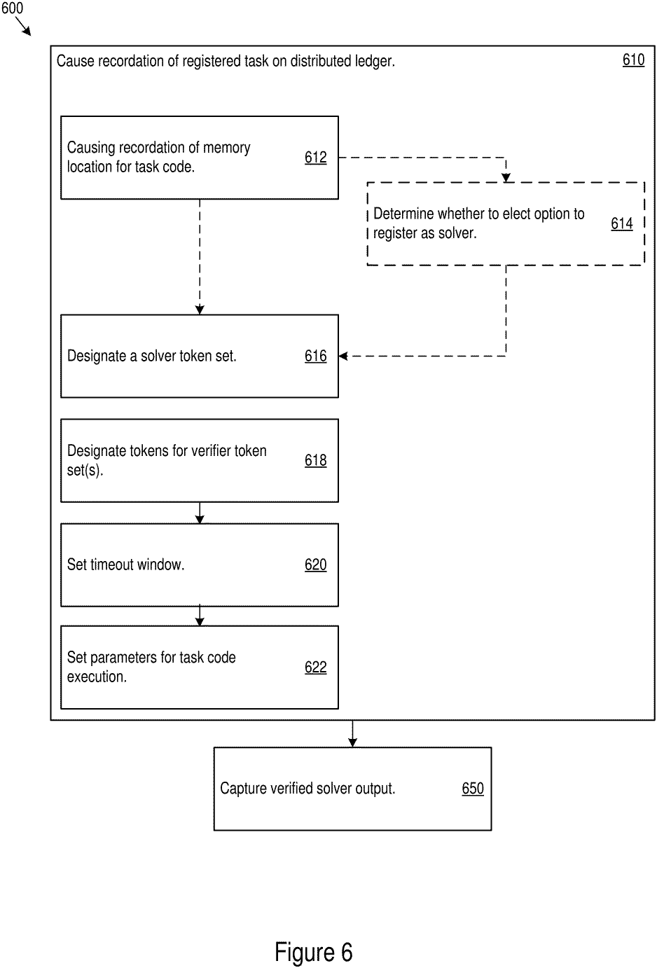

In the contention protocol, example task giver logic 600, which is shown in FIG. 6, may provide parameters for the interaction of the example solver logic 200 and verifier logic 400 through setup and initiation of the registered task 112.

The example task giver logic 600 may cause a registered task 112 to be recorded on the ledger 110 (610). Recording the registered task 112 may include recording an indication of a memory location where the task code 114 is stored (612). In some cases, the memory location may include a location on the ledger and/or associated storage. In some cases, the memory location may include a network resource, such as a network address, uniform resource locator (URL), database reference, and/or other network storage location. In some cases, the memory location may include a location to which requests for the task code 114 may be addressed.

In some implementations, the example task giver logic 600 may have an option to register the task giver 102 as the solver 120 for the registered task 112 (614). In some cases, controlling the timing of the recordation of the registered task 112 may functionally provide the task giver 102 a first opportunity to register as the solver 120. In some cases, the option to register as the solver may include a more formal option. For example, various implementations may provide a “first refusal” system where the task giver logic 600 may affirmatively accept or reject the solver role to complete the recordation of the registered task 112. In some cases, other prospective solvers may be barred from accepting the registered task 112 until an affirmative acceptance or rejection is recorded by the task giver logic 600.

The example task giver logic 600 may designate a solver token set (616). The designation of the solver token set may include an indication of a specific set of tokens that may serve as the set.

The example task giver logic 600 may designate one or more verifier token sets and/or a pool from which one or more verifier token sets may be apportioned once the number of successful verifiers (e.g., those verifiers 130 that obtain the right to assert control of a verifier token set) is established (618). The designation of the verifier token set may include an indication of a specific set of tokens that may serve as the set.

The example task giver logic 600 may set a timeout window for the solver 120 to provide the solver commitment and/or reveal the solver output (620). The time out window may be specified in various time formats. For example, days, hours, minutes, seconds using one or more timing standards, for example, local system time, networking timing indicators, government and/or non-governmental organization standards or other standards. In some implementations, the task giver logic 600 may specify the timeout window as a block limit on a timing ledger (which may, in some cases, include the ledger 110).

In some implementations, the timeout window may dynamically adapt to the hardware configuration of the solver execution system (e.g., SES 300). For example, the timeout window may be longer for SES systems with smaller computing capacities and larger for those with larger capacities. The hardware configuration of the SES may be determined via a record on the ledger, e.g., which may be made at a time at which the solver registers as a qualified solver, at a time at which the solver accepts the registered task 112, and/or other times of recordation on the ledger. In some cases, hardware configuration detection may be automatic as a part of a consensus protocol of the ledger, for example, participants of the ledger may be compelled to report hardware specifications. In an example, a network machine (e.g., operated via one or more participants of the ledger, or other associated nodes) may automatically detect/record hardware specifications of solvers, e.g., at the time of acceptance of the registered task and/or at other times of interaction with the ledger).

In some implementations, priority for solvers may be based (at least in part) on the hardware resources that the solver makes available for task code execution. For example, multiple solvers may accept a task during a defined acceptance period. Among the accepting solvers, those allocating more computing resources may be prioritized over those offering fewer. Additionally or alternatively, the size of the solver token set may scale with the amount of computing resources allocated by the solver.

The example task giver logic 600 may set various parameters for execution of the task code (622). For example, the example task giver logic 600 may set solver or verifier qualifications and/or other task code execution parameters.

After recordation of the registered task, the example task giver logic 600 may, in some cases, wait for the contention protocol to execute between the solver 120 and one or more verifiers 130 and then capture a verified solver output (650) and/or references to the verified execution of the task code 114 on the ledger 110. The verified solver output and/or references to the verified execution of the task code 114 on the ledger 110 may serve as proof of verified execution of the task code 114.

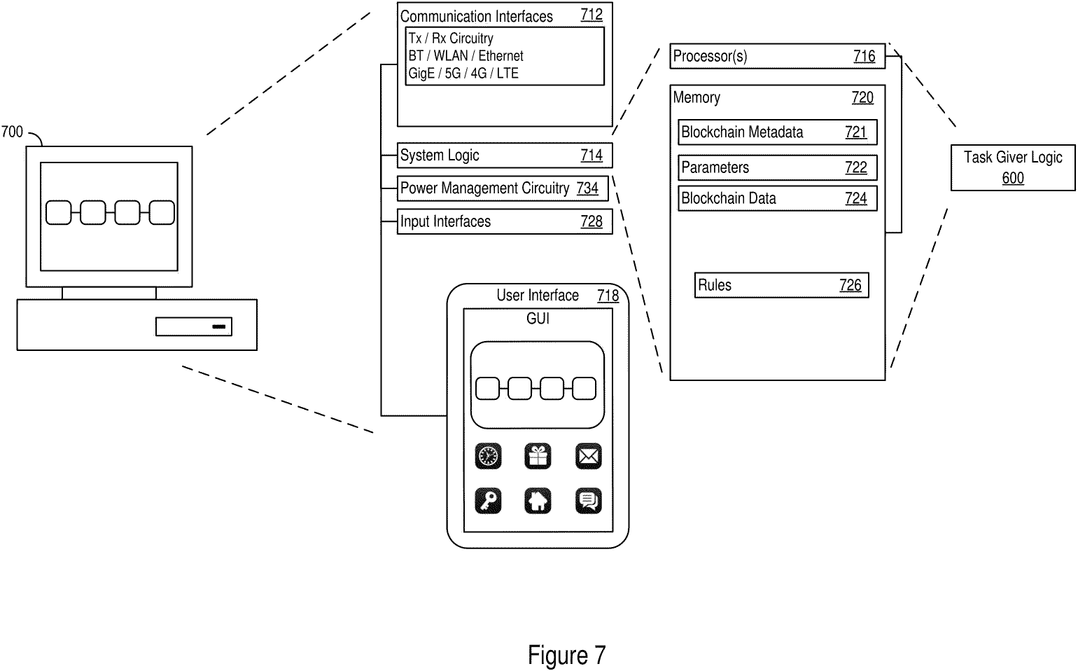

FIG. 7 shows an example task giver execution system (TGES) 700, which may provide a hardware environment for execution of contention protocol logic including the task giver logic 600. When configured using task giver logic, such as the example task giver logic 600, the hardware of the TGES 700 may be special purpose circuitry specifically configured to execute the operations of the task giver role in the contention protocol. The TGES 700 may be co-located with and/or share hardware with other systems such as the example solver execution system 300 and/or example verifier execution system 500. The TGES 700 may include system logic 714 to support encryption and decryption; parameter selection, token management; commitment generation; task writing; task execution; task verification; and/or other code execution operations. The system logic 714 may include processors 716, memory 720, and/or other circuitry, which may be used to implement the example task giver logic 600, any of the logics discussed above and/or other ledger logic, which may be used to execute ledger updates, execute code, and/or implement the contention-based protocol.

The memory 720 may be used to store blockchain metadata 722 and/or blockchain data 724 used in code execution. The memory 720 may further store parameters 721, such as encryption key values, generated random salt values, and/or other parameters that may facilitate sharing and manipulation of data. The memory may further store rules 726, which may support execution of contention-based protocols, implementation of blockchain consensus protocols, or other operations.

The memory 720 may further include applications and structures, for example, coded objects, templates, or one or more other data structures to support verifiable code execution. The TGES 700 may also include one or more communication interfaces 712, which may support wireless, e.g. Bluetooth, Wi-Fi, WLAN, cellular (5G, 4G, LTE/A), and/or wired, ethernet, Gigabit ethernet, optical networking protocols. Additionally, or alternatively, the communication interface 712 may support secure information exchanges, such as secure socket layer (SSL) or public-key encryption-based protocols for sending and receiving private data. The TGES 700 may include power management circuitry 734 and one or more input interfaces 728.

The TGES 700 may also include a user interface 718 that may include man-machine interfaces and/or graphical user interfaces (GUI). The GUI may be used to present options for solver option acceptance, code execution options, token management, ledger operations, and/or other options.

The TGES 700 may be deployed on distributed hardware. For example, various functions of the TGES 700, e.g., while implementing task giver logic, may be executed on cloud-based hardware, distributed static (and/or semi-static) network computing resources, and/or other distributed hardware systems. In various implementations, centralized and/or localized hardware systems may be used. For example, a unitary server or other nondistributed hardware system may perform task giver logic operations.

The methods, devices, processing, and logic described above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be embodied as a signal and/or data stream and/or may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may particularly include a storage medium and instructions stored in or on the medium, and the instructions when executed by the circuitry in a device may cause the device to implement any of the processing described above or illustrated in the drawings.

The implementations may be distributed as circuitry, e.g., hardware, and/or a combination of hardware and software among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

Table 1 shows various examples.

Table 1

Examples
1. A method including:
accessing a registered task on a ledger, the registered task including:
a reference to executable task code; and a designation of a solver token set;
accepting the registered task by registering a solver token counter-set on the ledger; performing the registered task by:
executing the task code to generate a solver output, optionally including executing the task code to generate the solver output within a timeout window, optionally the timeout window being specified in a number of blocks (e.g., a block limit) added to a timing ledger, where optionally the timing ledger includes the ledger; generating a solver commitment by encrypting the solver output; and
causing recordation of the solver commitment on the ledger;
responsive to a verifier causing recordation of a verifier commitment for the task on the ledger, facilitating comparison of a corresponding verifier output with the solver output by releasing a solver key for the solver commitment;
optionally, asserting control of the solver token set at a time that:
the verifier output matches the solver output; or the verifier output includes an error; and
optionally, surrendering the solver token counter-set at a time that:
the verifier output differs from the solver output; and the solver output includes an error, where
optionally, the method further includes one or more features of any other method in any other example in this table.
2. The method of example 1 or any other example in this table, where executing the task code to generate a solver output includes executing a smart contract.
3. The method of example 1 or any other example in this table, where encrypting the solver output includes encrypting the solver output using an encryption scheme that allows verification that the solver commitment was generated using the solver output by use of the solver key.
4. The method of example 1 or any other example in this table, where encrypting the solver output includes encrypting the solver output using a salt, where:
optionally, the salt is randomly generated, pseudorandomly generated, non deterministically generated, operator-selected, or any combination thereof; and
optionally, the method further includes providing the salt along with the solver key.
5. The method of example 1 or any other example in this table, where the registered task includes a task assigned by a task giver, where:
optionally, the task giver designates the solver token set.
6. The method of example 1 or any other example in this table, where registered task further includes a designation of a verifier token set, the verifier token set available to the verifier when:
the verifier output matches the solver output; or the verifier output differs from the solver output, and the solver output includes an error.
7. The method of example 1 or any other example in this table, where executing the task code to generate a solver output includes executing the task code to generate the solver output within a timeout window, where:
optionally, a designation of the timeout window is included within the registered task;
optionally, the timeout window is determined based on one or more characteristics of the executable task code, such as an expected runtime, a code size, a memory size, an average runtime, a comparison with other previously executed code, and/or other characteristic; and optionally, the timeout window is determined based on a default value associated with the ledger.
8. The method of example 1 or any other example in this table, further including obtaining a token in the solver token counter-set, where:
optionally, obtaining the token in the solver token counter-set includes obtaining a previous solver token set from a previous task; and optionally, obtaining the token in the solver token counter-set includes obtaining a previous solver token counter-set from a previous task.
9. The method of example 1 or any other example in this table, further including reasserting control of the solver token counter-set along with asserting control of the solver token set.
10. The method of example 1 or any other example in this table, where accepting the registered task includes recording a digitally-signed acceptance to the ledger, where:
optionally, the acceptance includes a smart contract and/or executed smart contract result.
10A. The method of example 1 or any other example in this table, further including causing recordation of an attempt to execute the task code, where:
optionally, the attempt record is signed using a client key specific to a solver or verifier client, where optionally, the signature is withheld unless the timeout window expires, when execution of the task code is uninterrupted; execution of the task code is incomplete; and/or the task code was inaccurately obtained;
optionally, the attempt recording includes a computational output metering record, where the computational output metering record includes an indication of computational resource usage during execution of the task code, where optionally, the computational resource usage includes processor cycles, memory operations, memory bus throughput, memory allocation, application execution duration, or other computational resource usage indications;
optionally, surrendering the solver or verifier token counter-set responsive to a timeout attributed to a non-attempt or interrupted attempt to execute the task code (e.g. solver’s fault)
optionally, causing a penalty to a task giver when the timeout window is too short to execute the task code through a good attempt (e.g., task giver’s fault).
11. A method including:
accessing a registered task on a ledger, the registered task including:
a reference to an executable task code; and a designation of a verifier token set;
based on a solver token counter-set registered on the ledger, determining that a solver has accepted the registered task;
verifying solver output for the registered task by:
executing the task code to generate a verifier output; generating a verifier commitment by encrypting the verifier output; and
prior to release of a solver key for decryption of a solver commitment containing the solver output, causing recordation of the verifier commitment on the ledger;
coordinated with a solver releasing the solver key, facilitating comparison the verifier output with the solver output by releasing a verifier key for the verifier commitment;
optionally, asserting control of the verifier token set at a time that:
the verifier output matches the solver output or, optionally, as soon as the verifier posts the verifier commitment; and/or
optionally, asserting control the solver token counter-set at a time that:
the verifier output differs from the solver output; and the solver output includes an error, where
optionally, the method further includes one or more features of any other method in any other example in this table.
12. The method of example 11 or any other example in this table, where:
optionally, executing the task code to generate a verifier output includes executing a smart contract; and
optionally, executing the task code to generate a verifier output includes executing the task code on a designated node and/or secure computing enclave (e.g., a logically and/or physically isolated computing resource group).
13. The method of example 11 or any other example in this table, where encrypting the verifier output includes encrypting the verifier output using an encryption scheme that allows verification that the verifier commitment was generated using the verifier output by use of the verifier key.
14. The method of example 11 or any other example in this table, where encrypting the verifier output includes encrypting the verifier output using a salt, where:
optionally, the salt is randomly generated, pseudorandomly generated, non deterministically generated, operator-selected, or any combination thereof; and
optionally, the method further includes providing the salt along with the verifier key.
15. The method of example 11 or any other example in this table, where the registered task includes a task assigned by a task giver, where:
optionally, the task giver designates the verifier token set.
16. The method of example 11 or any other example in this table, where the registered task further includes a designation of a solver token set, the solver token set available to the solver when:
the verifier output matches the solver output; or the verifier output differs from the solver output, and the verifier output includes an error.
17. The method of example 11 or any other example in this table, the registered task includes an associated timeout window, where:
optionally, a designation of the timeout window is included within the registered task;
optionally, the timeout window is determined based on one or more characteristics of the executable task code, such as an expected runtime, a code size, a memory size, an average runtime, a comparison with other previously executed code, and/or other characteristic; and optionally, the timeout window is determined based on a default value associated with the ledger;
optionally, the method further includes asserting control of a solver token counter-set when a solver fails to complete execution of the task code within the timeout window.
18. The method of example 1 or any other example in this table, further including obtaining a token in the verifier token counter-set, where:
optionally, obtaining the token in the verifier token counter-set includes obtaining a previous verifier token set from a previous task;
optionally, obtaining the token in the verifier token counter-set includes obtaining a previous verifier token set from a previous task;
optionally, obtaining the token in the solver token counter-set includes obtaining a previous solver token set from a previous task;
optionally, obtaining the token in the solver token counter-set includes obtaining a previous verifier token set from a previous task.
19. The method of example 1 or any other example in this table, further including reasserting control of the verifier token counter-set along with asserting control of the verifier token set.
20. The method of example 1, 11, or any other example in this table, further including:
causing termination of a token by using the token as an input for a termination code of a token-termination smart contract, where:
optionally, the method further includes causing acquisition of a termination- output responsive to using the token as the input for the termination code; and optionally, the termination-output includes a quantity of cryptocurrency.
21. A method including causing recordation of a registered task on a ledger, where the registered task includes a reference to executable code for which verifiable execution may be desired, where
optionally, capturing a reference to a portion of the ledger that includes a record of execution of at least of portion of the executable code;
optionally, opting to accept a first refusal to register as a solver for the registered task; and
optionally, the method further includes one or more features of any other method in any other example in this table.
22. A system including circuitry configured to implement the method of any other example in this table, where:
optionally, the circuitry is distributed; and optionally, the circuitry includes memory and/or one or more hardware-based processors.
23. A product including:
machine-readable media; and instructions stored on the machine-readable media, the instructions configured to cause a machine to implement the method of any other example, where:
optionally, the machine-readable media is other than a transitory signal;
optionally, the machine-readable media is non-transitory;
optionally, the instructions are executable.
24. A method including implementing any feature or combination of features in the description, examples, and/or drawings.
25. A system including circuitry configured to implement any feature or combination of features in the description, examples, and/or drawings, where:
optionally, the circuitry is distributed; and
optionally, the circuitry includes memory and/or one or more hardware-based processors.
26. A product including:
machine-readable media; and
instructions stored on the machine-readable media, the instructions configured to cause a machine to implement any feature or combination of features in the description, examples, and/or drawings, where:
optionally, the machine-readable media is other than a transitory signal;
optionally, the machine-readable media is non-transitory;
optionally, the instructions are executable.

Headings and/or subheadings used herein are intended only to aid the reader with understanding described implementations. The invention is defined by the claims.

What is claimed is:

1. A method including:
accessing a registered task on a ledger, the registered task including:
a reference to executable task code; and
a designation of a solver token set;
accepting the registered task by registering a solver token counter-set on the ledger;
performing the registered task by:
executing the task code to generate a solver output within a timeout window, the timeout window being specified as a number of block addition occurrences allowed for a timing ledger before a timeout occurs;
generating a solver commitment by encrypting the solver output; and
causing recordation of the solver commitment on the ledger; and
responsive to a verifier causing recordation of a verifier commitment for the registered task on the ledger, facilitating comparison of a corresponding verifier output with the solver output by releasing a solver key for the solver commitment.

2. The method of claim 1, further including asserting control of the solver token set at a time that:
the verifier output matches the solver output; or
the verifier output includes an error.

3. The method of claim 1, further including surrendering the solver token counter-set at a time that:
the verifier output differs from the solver output; and
the solver output includes an error.

4. The method of claim 1, where the timing ledger includes the ledger.

5. The method of claim 1, where the timing ledger is different from the ledger.

6. The method of claim 1, where executing the task code to generate a solver output includes executing a smart contract.

7. The method of claim 1, where encrypting the solver output includes encrypting the solver output using an encryption scheme that allows for verification, using the solver key, that the solver commitment was generated based on the solver output.

8. The method of claim 1, where the registered task includes a task assigned by a task giver, where:
the task giver designates the solver token set.

9. The method of claim 1, where the registered task further includes a designation of a verifier token set, the verifier token set available to the verifier when:
the verifier output matches the solver output; or
the verifier output differs from the solver output, and the solver output includes an error.

10. The method of claim 1, further including reasserting control of the solver token counter-set and asserting control of the solver token set.

11. The method of claim 1, where accepting the registered task includes recording a digitally-signed acceptance to the ledger.

12. The method of claim 1, further including causing recordation of an attempt to execute the task code, where the recordation of the attempt is signed using a client key specific to a solver.

13. A product including:
machine-readable media other than a transitory signal; and
instructions stored on the machine-readable media, the instructions, when executed, configured to cause a machine to:
access a registered task on a ledger, the registered task including:
a reference to executable task code; and
a designation of a solver token set;
accept the registered task by registering a solver token counter-set on the ledger;
perform the registered task by:
executing the task code to generate a solver output within a timeout window, the registered task specifying a format and length for the timeout window;
generating a solver commitment by encrypting the solver output; and
causing recordation of the solver commitment on the ledger; and
responsive to a verifier causing recordation of a verifier commitment for the registered task on the ledger, facilitate comparison of a corresponding verifier output with the solver output by releasing a solver key for the solver commitment.

14. The product of claim 13, where the instructions are further configured to cause the machine to assert control of the solver token set at a time that:
the verifier output matches the solver output; or
the verifier output includes an error.

15. The product of claim 13, where the instructions are further configured to cause the machine to surrender the solver token counter-set at a time that:
the verifier output differs from the solver output; and
the solver output includes an error.

16. The product of claim 13, where the instructions are further configured to cause the machine to execute the task code to generate a solver output by executing a smart contract.

17. The product of claim 13, where the instructions are further configured to cause the machine to encrypt the solver output by encrypting the solver output using an encryption scheme that allows for verification, using the solver key, that the solver commitment was generated based on the solver output.

18. A system including:
means for accessing a registered task on a ledger, the registered task including:
a reference to executable task code; and
a designation of a solver token set;
means for accepting the registered task by registering a solver token counter-set on the ledger; means for performing the registered task by:
executing the task code to generate a solver output within a timeout window, the timeout window being specified as a number of block addition occurrences allowed for a timing ledger before a timeout occurs;
generating a solver commitment by encrypting the solver output; and
causing recordation of the solver commitment on the ledger; and
means for facilitating, responsive to a verifier causing recordation of a verifier commitment for the registered task on the ledger, comparison of a corresponding verifier output with the solver output by releasing a solver key for the solver commitment.

19. The system of claim 18, where the registered task further includes a designation of a verifier token set, the verifier token set available to the verifier when:
the verifier output matches the solver output; or
the verifier output differs from the solver output, and the solver output includes an error.

20. The system of claim 18, further including means for reasserting control of the solver token counter-set and asserting control of the solver token set.
